(19) United States
(12) Patent Application Publication
(10) Pub. No.: US 2026/0162232 A1
(43) Pub. Date: Jun. 11, 2026

(54) MITIGATING STABILIZATION EFFECTS TO RESTORE NATURAL MOTION IN VIDEO FRAMING

(71) Applicant: GoPro, Inc., San Mateo, CA (US)

(72) Inventors: Emmanuel Simon, Asnières-sur-Seine (FR); Nicolas Rahmouni, Paris (FR); Simon Bourigault, San Mateo, CA (US)

(21) Appl. No.: 19/416,555

(22) Filed: Dec. 11, 2025

Related U.S. Application Data
(60) Provisional application No. 63/730,833, filed on Dec. 11, 2024.

(51) Int. Cl. G06T 5/70; G06T 3/14; G06T 3/40; G06T 3/60; G06T 5/20; G06T 5/50; G06T 7/20; G06T 11/00

(52) U.S. Cl. CPC G06T 5/70; G06T 3/14; G06T 3/40; G06T 3/60; G06T 5/20; G06T 5/50; G06T 7/20; G06T 11/00; G06T 2207/10016; G06T 2207/20182

(57) ABSTRACT

Methods, systems, and devices for framing videos are described. In some implementations, an image capture device may obtain video information defining a video captured over a duration in a capture reference frame, wherein the device may rotate in three rotational degrees of freedom relative to a global reference frame. Stabilized framing information may be obtained to define a viewing window that may compensate for relative rotation between the capture reference frame and the global reference frame in at least two rotational degrees of freedom. Modified framing information may be generated using a noise injection process to attenuate the compensation provided by the stabilized framing information. The visual content within the modified viewing window may be determined and presented as a function of progress through the video's length, resulting in a viewing experience that may balance stability against jitter while preserving naturalistic motion and operator intent.

### CROSS REFERENCE TO RELATED APPLICATIONS

The present Application for Patent claims the benefit of priority from Provisional U.S. Patent Application No. 63/730,833 filed on Dec. 11, 2024, assigned to the assignee hereof, and which is hereby incorporated by reference in its entirety.

### FIELD OF TECHNOLOGY

The present disclosure relates generally to information base systems and information processing, and more specifically to mitigating stabilization effects to restore natural motion in video framing.

### BACKGROUND

Video capture devices, such as cameras and smartphones, are commonly used to record dynamic activities in various fields. These devices may experience rotational and translational motion during operation, which can affect the stability of the captured video. To address this, many devices are equipped with motion sensors, including gyroscopes and accelerometers, that generate orientation information during video capture. This information may be processed by stabilization algorithms to produce stabilized framing information, which defines a viewing window that compensates for relative motion between the device's capture reference frame and a global reference frame.

### SUMMARY

The described techniques relate to improved methods, systems, devices, and apparatuses for mitigating stabilization effects to restore natural motion in video framing. Some implementations provide a system and method for mitigating rigid stabilization effects in video, including spherical video, by generating modified framing information that may reintroduce controlled rotational motion into the viewing window. The system may obtain stabilized framing information, which defines a viewing window locked to a global reference frame, and may determine the inverse of this information to recover the original rotational motion of the image capture device during the capture duration. The inverse stabilized framing information may be smoothed using quaternion-based filtering techniques to remove high-frequency jitter while preserving lower-frequency motion trends, such as panning or banking. A user-selectable control input may determine the level of compensation mitigation applied to the smoothed information, enabling the system to produce final framing adjustment information that reflects a controlled amount of the original motion.

The final framing adjustment information may be combined with the stabilized framing information to generate modified framing information, which may define a viewing window that attenuates rigid stabilization effects while maintaining stability against high-frequency artifacts. This modified viewing window may allow the video to respond to significant camera movements, preserving operator intent and naturalistic motion while eliminating nausea-inducing instability. By implementing this system and method, some implementations may achieve a balance between stability and dynamic motion, ensuring that visually interesting and intended content remains in the frame while enhancing the immersive quality of the video presentation.

A method of framing videos is described. The method may include obtaining video information defining a video, the video having a progress length, the video including visual content viewable as a function of progress through the progress length, the video captured by an image capture device over a capture duration in a capture reference frame associated with the image capture device, wherein during the capture duration the image capture device may rotate in three rotational degrees of freedom with respect to a global reference frame of the visual content, thereby causing corresponding rotation between the capture reference frame and the global reference frame in the three rotational degrees of freedom. The method may include obtaining stabilized framing information that may define a viewing window of the visual content for presentation as a function of progress through the progress length of the video, wherein the framing information may include viewing window orientation information that may define rotation of the viewing window with respect to the capture reference frame in at least two of the rotational degrees of freedom as a function of progress through the progress length that may compensate for relative rotation between the capture reference frame and the global reference frame in the at least two rotational degrees of freedom during the capture duration. The method may include generating modified framing information that may define a modified viewing window of the visual content for presentation as a function of progress through the progress length of the video, wherein the modified framing information may attenuate compensation for relative rotation between the capture reference frame and the global reference frame provided by the stabilized framing information in the at least two rotational degrees of freedom, where the modified framing information may be derived from the stabilized framing information with a noise injection process. The method may include determining the visual content within the viewing window defined by the modified framing information as a function of progress through the progress length of the video. The method may include presenting the visual content determined to be within the viewing window defined by the modified framing information as a function of progress through the progress length of the video.

A system configured for framing videos is described. The system may include a processor, memory coupled with the processor, and instructions stored in the memory and executable by the processor. The system may obtain video information defining a video, where the video may have a progress length and may include visual content viewable as a function of progress through the progress length. The video may be captured by an image capture device over a capture duration in a capture reference frame associated with the image capture device, wherein during the capture duration the image capture device may rotate in three rotational degrees of freedom with respect to a global reference frame of the visual content, thereby causing corresponding rotation between the capture reference frame and the global reference frame in the three rotational degrees of freedom. The system may obtain stabilized framing information that may define a viewing window of the visual content for presentation as a function of progress through the progress length of the video, wherein the framing information may include viewing window orientation information that may define rotation of the viewing window with respect to the capture reference frame in at least two of the rotational degrees of freedom as a function of progress through the progress length, and may compensate for relative rotation between the capture reference frame and the global reference frame in the at least two rotational degrees of freedom during the capture duration. The system may generate modified framing information that may define a modified viewing window of the visual content for presentation as a function of progress through the progress length of the video, wherein the modified framing information may attenuate compensation for relative rotation between the capture reference frame and the global reference frame provided by the stabilized framing information in the at least two rotational degrees of freedom, and where the modified framing information may be derived from the stabilized framing information with a noise injection process. The system may determine the visual content within the viewing window defined by the modified framing information as a function of progress through the progress length of the video. The system may present the visual content determined to be within the viewing window defined by the modified framing information as a function of progress through the progress length of the video.

A non-transitory computer-readable medium storing code for video framing is described. The code may include instructions executable by a processor to obtain video information defining a video, wherein the video may have a progress length, may include visual content viewable as a function of progress through the progress length, and may be captured by an image capture device over a capture duration in a capture reference frame associated with the image capture device, wherein during the capture duration the image capture device may rotate in three rotational degrees of freedom with respect to a global reference frame of the visual content, thereby causing corresponding rotation between the capture reference frame and the global reference frame in the three rotational degrees of freedom. The code may include instructions executable by a processor to obtain stabilized framing information that may define a viewing window of the visual content for presentation as a function of progress through the progress length of the video, wherein the stabilized framing information may include viewing window orientation information that may define rotation of the viewing window with respect to the capture reference frame in at least two of the rotational degrees of freedom as a function of progress through the progress length, and may compensate for relative rotation between the capture reference frame and the global reference frame in the at least two rotational degrees of freedom during the capture duration. The code may include instructions executable by a processor to generate modified framing information that may define a modified viewing window of the visual content for presentation as a function of progress through the progress length of the video, wherein the modified framing information may attenuate compensation for relative rotation between the capture reference frame and the global reference frame provided by the stabilized framing information in the at least two rotational degrees of freedom, and may be derived from the stabilized framing information with a noise injection process. The code may include instructions executable by a processor to determine the visual content within the viewing window defined by the modified framing information as a function of progress through the progress length of the video. The code may include instructions executable by a processor to present the visual content determined to be within the viewing window defined by the modified framing information as a function of progress through the progress length of the video.

In some examples of the method, systems, and non-transitory computer-readable medium described herein, the three degrees of freedom may include yaw, pitch, and roll.

In some examples of the method, systems, and non-transitory computer-readable medium described herein, the at least two of the three rotational degrees of freedom may include pitch and roll.

In some examples of the method, systems, and non-transitory computer-readable medium described herein, the at least two of the three rotational degrees of freedom may include all three of the rotational degrees of freedom.

Some examples of the method, systems, and non-transitory computer-readable medium described herein may further include operations, features, means, or instructions for determining inverse stabilized framing information that may reverse compensation of the stabilized framing information for the relative rotation between the capture reference frame and the global reference frame during the capture duration. The operations may further include determining initial framing adjustment information by smoothing the inverse stabilized framing information over the progress length of the video, obtaining a level of compensation mitigation, determining final framing adjustment information by applying the level of compensation mitigation to the initial framing adjustment information, and generating the modified framing information by applying the final framing adjustment information to the stabilized framing information.

In some examples of the method, systems, and non-transitory computer-readable medium described herein, the inverse stabilized framing information may include quaternions describing rotation for individual frames of the video over the progress length of the video.

In some examples of the method, systems, and non-transitory computer-readable medium described herein, smoothing the inverse stabilized framing information over the progress length of the video may include deriving, from the quaternions, separate angle of rotation functions describing rotation in individual ones of the at least two or more rotational degrees of freedom as a function of progress through the progress length of the video. The smoothing may further include generating smoothed angle of rotation functions for the individual ones of the at least two rotational degrees of freedom by separately smoothing the angle of rotation functions as a function of progress through the progress length of the video, and deriving smoothed quaternions from the smoothed angle of rotation functions.

In some examples of the method, systems, and non-transitory computer-readable medium described herein, generating smoothing of the angle of rotation functions may include applying bandpass filtering and/or an amplitude limiting function to the separate angle of rotation functions.

In some examples of the method, systems, and non-transitory computer-readable medium described herein, the initial framing adjustment information may include the smoothed quaternions.

In some examples of the method, systems, and non-transitory computer-readable medium described herein, determining the final framing adjustment information may include applying a spherical linear interpolation operation to the smoothed quaternions, and the level of compensation mitigation may determine a parameter of the spherical linear interpolation operation applied to the smoothed quaternions.

In some examples of the method, systems, and non-transitory computer-readable medium described herein, the compensation for relative rotation between the capture reference frame and the global reference frame in the at least two rotational degrees of freedom during the capture duration by the stabilized framing information may significantly reduce or effectively eliminate relative rotation of the viewing window with respect to the global reference frame in the at least two rotational degrees of freedom.

In some examples of the method, systems, and non-transitory computer-readable medium described herein, the stabilized framing information may be included in the video information.

In some examples of the method, systems, and non-transitory computer-readable medium described herein, the stabilized framing information may be derived from orientation information generated by one or more motion sensors of the image capture device.

In some examples of the method, systems, and non-transitory computer-readable medium described herein, the modified framing information may be generated in response to a user input selecting a compensation mitigation level for the viewing window.

In some examples of the method, systems, and non-transitory computer-readable medium described herein, the smoothing of the inverse stabilized framing information may include applying a low-pass filter to reduce high-frequency jitter in the rotational degrees of freedom.

In some examples of the method, systems, and non-transitory computer-readable medium described herein, the modified framing information may define a viewing window that maintains a horizon orientation relative to the global reference frame while allowing controlled rotational motion in the yaw axis.

In some examples of the method, systems, and non-transitory computer-readable medium described herein, the modified framing information may be generated by combining the stabilized framing information with the smoothed motion information through quaternion multiplication.

In some examples of the method, systems, and non-transitory computer-readable medium described herein, the level of compensation mitigation may be dynamically adjusted in response to changes in the rotational motion of the image capture device during the progress length of the video.

In some examples of the method, systems, and non-transitory computer-readable medium described herein, the modified framing information may be generated to preserve operator-intended camera movements, including panning and tilting, while reducing unintended jitter.

In some examples of the method, systems, and non-transitory computer-readable medium described herein, the modified framing information may be generated to provide a viewing window that adapts to significant rotational movements while maintaining stability in the pitch and roll axes.

As used herein, any association (or relation, or reflection, or indication, or correspondence) involving processor(s), synchronous condenser(s), and/or another entity or object that interacts with any part of the system and/or plays a part in the operation of the system, may be a one-to-one association, a one-to-many association, a many-to-one association, and/or a many-to-many association, or an N-to-M association (note that N and M may be different numbers greater than 1). As used herein, the phrase “configured to” is intended to be interpreted broadly, as “being capable of or suitable for performing” some function or feature, without requiring any adaptations to provide said function or feature.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular forms of “a”, “an”, and “the” include plural referents unless the context clearly dictates otherwise.

### BRIEF DESCRIPTION OF THE DRAWINGS

FIG. 1 illustrates an example of a system for information processing configured for mitigating stabilization effects to restore natural motion in video framing in accordance with aspects of the present disclosure.

FIG. 2 shows labeled diagram sketch which supports techniques for mitigating stabilization effects to restore natural motion in video framing in accordance with various aspects of the present disclosure.

FIG. 3 shows sketch with labels which supports techniques for mitigating stabilization effects to restore natural motion in video framing in accordance with various aspects of the present disclosure.

FIG. 4 shows tree house diagram which supports techniques for mitigating stabilization effects to restore natural motion in video framing in accordance with various aspects of the present disclosure.

FIG. 5 shows outdoor scene diagram which supports techniques for mitigating stabilization effects to restore natural motion in video framing in accordance with various aspects of the present disclosure.

FIG. 6 illustrates a flowchart that supports techniques for mitigating stabilization effects to restore natural motion in video framing in accordance with various aspects of the present disclosure.

FIG. 7 illustrates an example of a process flow for mitigating stabilization effects to restore natural motion in video framing in accordance with various aspects of the present disclosure.

FIG. 8 shows a diagram of a system including a device for mitigating stabilization effects to restore natural motion in video framing in accordance with various aspects of the present disclosure.

FIG. 9 shows a flowchart illustrating a method for mitigating stabilization effects to restore natural motion in video framing in accordance with various aspects of the present disclosure.

FIG. 10 show a flowchart illustrating a method for mitigating stabilization effects to restore natural motion in video framing in accordance with various aspects of the present disclosure.

### DETAILED DESCRIPTION

Methods, systems, devices, and apparatuses for mitigating stabilization effects to restore natural motion in video framing are disclosed. In some examples, conventional video stabilization techniques may rigidly lock the viewing window to a global reference frame, eliminating most or all rotational motion caused by the relative movement of the image capture device during video recording. While this approach may reduce jitter and instability, it may often produce sterile and unnatural video presentations by suppressing operator-intended camera movements, such as panning, tilting, or banking. This rigid stabilization may exclude visually interesting or intended content from the frame, diminishing the immersive and dynamic feel of the original activity. Furthermore, existing stabilization methods may fail to provide a mechanism for selectively reintroducing controlled rotational motion into the viewing window, leaving users unable to achieve a balance between stability and naturalistic motion. There may be a need for a system and method that may attenuate rigid stabilization effects while preserving operator intent and enhancing the visual experience of stabilized video.

In some implementations, video information may be captured by an image capture device, such as a camera, over a defined period during which the device may rotate in three rotational degrees of freedom, including yaw, pitch, and roll, relative to a global reference frame. This rotation may result in relative motion between the device's reference frame and the global reference frame, which may affect the stability of the captured video. To address this, stabilized framing information may be generated to define a viewing window for the visual content, compensating for the relative rotation between the device's reference frame and the global reference frame. This stabilization may occur in two or three rotational degrees of freedom and may significantly reduce or eliminate relative rotation of the viewing window with respect to the global reference frame. However, rigid stabilization methods may suppress rotational motion entirely, locking the viewing window to the global reference frame and potentially excluding operator-intended movements, such as panning or banking, as well as omitting visual content intended to be included in the frame.

In some implementations, the original rotational motion of the image capture device during the capture period may be recovered by determining the inverse of the stabilized framing information. This inverse operation may reverse the compensation applied by the stabilization process, restoring the raw relative rotation between the device's reference frame and the global reference frame. The inverse stabilized framing information may be derived from orientation information generated by motion sensors, such as gyroscopes and accelerometers, or may be obtained from metainformation stored with the video. Once recovered, the inverse stabilized framing information may be processed to remove high-frequency jitter while preserving lower-frequency motion trends, such as banking or panning. This smoothing process may ensure that the reintroduced motion is naturalistic and free of chaotic artifacts. Filtering methods, such as bandpass filtering or amplitude limiting, may be applied to selectively remove unwanted noise while retaining meaningful motion information. Smoothing may be performed separately for each rotational degree of freedom, such as yaw, pitch, and roll, by deriving individual angle-of-rotation functions for each degree of freedom, smoothing these functions, and converting the smoothed information back into mathematical representations of rotation.

In some implementations, a user-selectable control input may allow the user to determine the level of compensation mitigation applied to the smoothed motion information. This input may be provided through a user interface, such as buttons or a touchscreen, enabling the user to customize the degree to which the original motion is reintroduced into the viewing window. The level of compensation mitigation may be applied using a mathematical operation that interpolates between the stabilized framing information and the smoothed motion information. The user-selected level may determine a parameter of this interpolation, controlling the balance between rigid stabilization and the reintroduction of naturalistic motion. By allowing user control, some implementations may ensure that the final video presentation aligns with the operator's intent, preserving intended visual content and motion dynamics.

In some implementations, modified framing information may be generated by combining the final adjustment information, derived from the smoothed motion information and user-selected compensation mitigation, with the stabilized framing information. This modified framing information may define a viewing window that attenuates the rigid compensation provided by conventional stabilization methods. The modified framing information may allow the viewing window to drift or tilt in response to significant camera movements while remaining stable against high-frequency jitter. This reintroduction of motion may be controlled and naturalistic, ensuring that the video presentation reflects the operator's intended movements and visual content. The visual content within the modified viewing window may be determined for each frame of the video and presented through a video output module, such as a display screen. Additionally, the modified video may be transferred to external devices via an information transfer interface, such as a universal serial bus or wireless communication module.

In some implementations, mathematical representations of rotation may be used to describe the orientation of the viewing window for individual frames of the video. These representations may provide a compact and efficient way to calculate rotational motion, enabling precise operations for smoothing and compensation mitigation. Mathematical operations may be applied to combine the smoothed motion information with the stabilized framing information, generating the modified framing information. Independent control over each rotational degree of freedom, such as yaw, pitch, and roll, may be enabled, allowing the viewing window to respond differently to movements in each degree of freedom. By processing each rotational degree of freedom separately, some implementations may ensure that the reintroduced motion reflects the dynamics of the original activity, providing a tailored motion profile for the video.

In some implementations, the described methods may be applied to spherical video, where the visual content may encompass a 360-degree environment. In this context, the viewing window may function as a virtual camera viewport that extracts a subset of the spherical visual content for presentation. Stabilized framing information for spherical video may include horizon locking or direction locking. Horizon locking may stabilize the viewing window with respect to pitch and roll, keeping the horizon level and vertical alignment consistent. Direction locking may stabilize the viewing window on all three rotational degrees of freedom, creating a view that remains fixed on a specific coordinate within the spherical environment. By attenuating rigid stabilization effects, some implementations may ensure that spherical video presentations retain naturalistic motion while maintaining stability.

In some implementations, a process may be introduced to attenuate the rigid stabilization effects of conventional methods. This process may involve recovering raw motion information, smoothing the information, applying compensation mitigation, and generating modified framing information. The process may ensure that the reintroduced motion is controlled and does not compromise the stability of the video. An image capture device equipped with motion sensors, such as gyroscopes and accelerometers, may generate orientation information during video capture, which may be accessed by a processor. The processor may perform the inverse operation, smoothing, compensation mitigation, and generation of modified framing information. A user interface may provide control inputs for selecting the level of compensation mitigation, ensuring that the final video presentation aligns with user preferences and operator intent. The modified visual content may then be presented through a video output module, such as a display screen, and transferred to external devices via a information transfer interface, such as a universal serial bus or wireless communication module.

Aspects of the subject matter described in this disclosure can be implemented to realize one or more of the following potential advantages. The described techniques may be implemented to support enhanced user control over video stabilization settings, allowing for tailored adjustments that may align with individual preferences or specific use cases. The system may provide a mechanism for selectively reintroducing naturalistic motion into stabilized video, which may improve the immersive quality of the visual content while maintaining stability against disruptive artifacts. By utilizing mathematical representations of rotation, the methods may enable efficient processing and precise adjustments to the viewing window orientation, which may reduce computational overhead and improve performance on resource-constrained devices. The ability to independently control rotational degrees of freedom may allow the system to adapt to diverse motion profiles, which may be beneficial for capturing dynamic activities or environments. The described techniques may also facilitate the creation of video presentations that preserve operator intent, ensuring that intended visual elements and movements are retained within the viewing window.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to mitigating stabilization effects to restore natural motion in video framing.

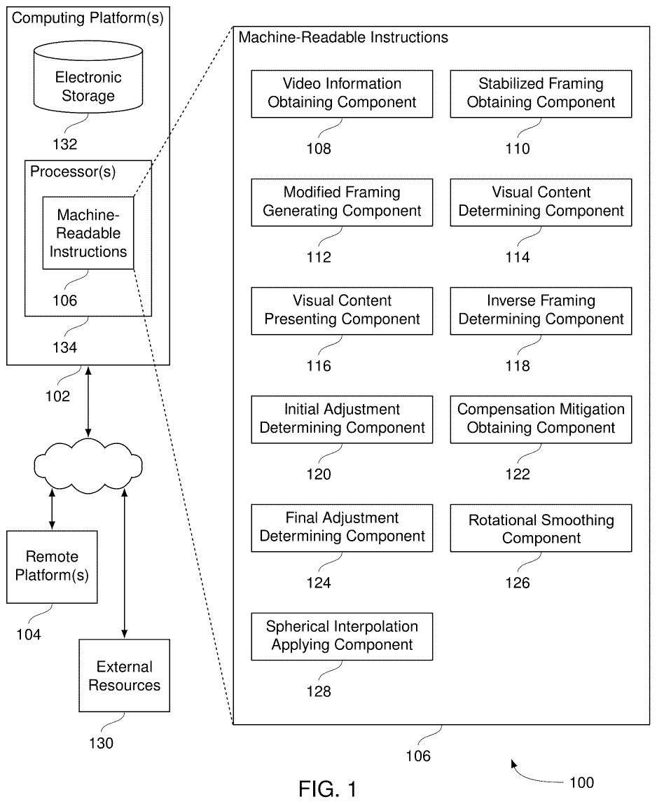

FIG. 1 illustrates an example of a system 100 for information processing configured for mitigating stabilization effects to restore natural motion in video framing in accordance with aspects of the present disclosure. For example, the system 100 may be configured for dynamically displaying information based on a context associated with a smart card, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction components. The instruction components may include computer program components. The instruction components may include one or more of a video information obtaining component 108, a stabilized framing obtaining component 110, a modified framing generating component 112, a visual content determining component 114, a visual content presenting component 116, an inverse framing determining component 118, an initial adjustment determining component 120, a compensation mitigation obtaining component 122, a final adjustment determining component 124, a rotational smoothing component 126, a spherical interpolation applying component 128 and/or other instruction components.

The video information obtaining component 108 may be configured as or otherwise support a means for obtaining video information defining a video, the video having a progress length, the video including visual content viewable as a function of progress through the progress length, the video captured by an image capture device over a capture duration in a capture reference frame associated with the image capture device, wherein during the capture duration the image capture device may rotate in three rotational degrees of freedom with respect to a global reference frame of the visual content, thereby causing corresponding rotation between the capture reference frame and the global reference frame in the three rotational degrees of freedom.

In some implementations, the video information obtaining component 108 may include a memory module configured to store video information during the capture duration. The video information obtaining component 108 may support integration with motion sensors, such as gyroscopes and accelerometers, to record orientation information corresponding to the rotational degrees of freedom. The video information obtaining component 108 may be configured to process spherical video information captured by dual opposing lenses to encompass the entire capture environment.

In some implementations, the video information obtaining component 108 may determine stabilized framing information that defines a viewing window orientation relative to the global reference frame. The video information obtaining component 108 may support the extraction of raw orientation information from the image capture device during the capture duration. The video information obtaining component 108 may include an information transfer interface to transmit video information to external devices for further processing.

The stabilized framing obtaining component 110 may be configured as or otherwise support a means for obtaining stabilized framing information that defines a viewing window of the visual content for presentation as a function of progress through the progress length of the video, wherein the framing information may include viewing window orientation information that may define rotation of the viewing window with respect to the capture reference frame in at least two of the rotational degrees of freedom as a function of progress through the progress length that may compensate for relative rotation between the capture reference frame and the global reference frame in the at least two rotational degrees of freedom during the capture duration. In some implementations, the stabilized framing obtaining component 110 may determine stabilized framing information based on horizon locking techniques that may maintain vertical alignment consistent with gravity. In some implementations, the stabilized framing obtaining component 110 may determine stabilized framing information based on direction locking techniques that may stabilize the viewing window across all three rotational degrees of freedom relative to the global reference frame. In some implementations, the stabilized framing obtaining component 110 may determine stabilized framing information that may include quaternions describing the rotation of the viewing window relative to the capture reference frame.

The modified framing generating component 112 may be configured as or otherwise support a means for generating modified framing information that defines a modified viewing window of the visual content for presentation as a function of progress through the progress length of the video, wherein the modified framing information may attenuate compensation for relative rotation between the capture reference frame and the global reference frame provided by the stabilized framing information in the at least two rotational degrees of freedom, where the modified framing information may be derived from the stabilized framing information with a noise injection process. In some implementations, the modified framing generating component 112 may determine the modified framing information by applying a smoothing operation to inverse stabilized framing information to remove high-frequency jitter while preserving lower-frequency motion trends. In some implementations, the modified framing generating component 112 may determine the modified framing information by incorporating user-selectable control inputs that may adjust the level of compensation mitigation applied to the smoothed motion information. In some implementations, the modified framing generating component 112 may determine the modified framing information by performing a spherical linear interpolation operation on smoothed quaternions, where the interpolation parameter may correspond to the user-selected level of compensation mitigation.

The visual content determining component 114 may be configured as or otherwise support a means for determining the visual content within the viewing window defined by the modified framing information as a function of progress through the progress length of the video. In some implementations, the visual content determining component 114 may determine visual content by analyzing pixel information within the boundaries of the modified viewing window. In some implementations, the visual content determining component 114 may determine visual content by referencing metainformation associated with the video frames to identify specific objects or features within the modified viewing window. In some implementations, the visual content determining component 114 may determine visual content by applying geometric transformations to align the modified viewing window orientation with the spherical video information.

The visual content presenting component 116 may be configured as or otherwise support a means for presenting the visual content determined to be within the viewing window defined by the modified framing information as a function of progress through the progress length of the video. In some implementations, the visual content presenting component 116 may present the visual content through a display module integrated into the image capture device, such as an LCD screen or OLED panel. In some implementations, the visual content presenting component 116 may transmit the visual content to external devices, such as smartphones or computers, via a wireless communication module, which may include Wi-Fi or Bluetooth connectivity. In some implementations, the visual content presenting component 116 may support output to external displays, such as televisions or projectors, through a physical information transfer interface, which may include HDMI or USB connections.

In some examples, the video information obtaining component 108 may be configured as or otherwise support a means for obtaining video information that may define three degrees of freedom including yaw, pitch, and roll. In some implementations, the video information obtaining component 108 may determine orientation information corresponding to the three degrees of freedom by accessing motion sensor outputs, such as gyroscopes and accelerometers, integrated into the image capture device. In some implementations, the video information obtaining component 108 may record spherical video information encompassing the entire capture environment, which may include stitched content from dual opposing lenses. In some implementations, the video information obtaining component 108 may store the video information in a memory module during the capture duration, which may allow subsequent access for processing rotational information.

In some examples, the stabilized framing obtaining component 110 may be configured as or otherwise support a means for obtaining stabilized framing information that may define rotation of the viewing window with respect to the capture reference frame in at least two of the three rotational degrees of freedom, wherein the at least two of the three rotational degrees of freedom may include pitch and roll. In some implementations, the stabilized framing obtaining component 110 may determine stabilized framing information by referencing motion sensor information, such as gyroscope outputs, to determine and/or track changes in pitch and roll during the capture duration. In some implementations, the stabilized framing obtaining component 110 may determine stabilized framing information by analyzing the orientation of the viewing window relative to a global reference frame to maintain consistent alignment in pitch and roll. In some implementations, the stabilized framing obtaining component 110 may determine stabilized framing information by applying filtering techniques to smooth abrupt changes in pitch and roll orientation over the progress length of the video.

In some examples, the stabilized framing obtaining component 110 may be configured as or otherwise support a means for obtaining stabilized framing information that may define rotation of the viewing window with respect to the capture reference frame in at least two of the three rotational degrees of freedom, wherein the at least two of the three rotational degrees of freedom may include all three of the rotational degrees of freedom. In some implementations, the stabilized framing obtaining component 110 may determine stabilized framing information by referencing spherical video information captured by dual opposing lenses to encompass the entire capture environment. In some implementations, the stabilized framing obtaining component 110 may determine stabilized framing information by accessing raw orientation information stored during the capture duration to track rotational changes in the viewing window. In some implementations, the stabilized framing obtaining component 110 may determine stabilized framing information by applying horizon locking techniques to maintain consistent vertical alignment relative to gravity.

In some examples, the inverse framing determining component 118 may be configured as or otherwise support a means for determining inverse stabilized framing information that may reverse compensation of the stabilized framing information for the relative rotation between the capture reference frame and the global reference frame during the capture duration. In some implementations, the inverse framing determining component 118 may determine inverse stabilized framing information by accessing raw orientation information stored during the capture duration to identify rotational changes in the capture reference frame. In some implementations, the inverse framing determining component 118 may determine inverse stabilized framing information by applying mathematical operations to stabilized framing information to extract the original rotational motion of the image capture device. In some implementations, the inverse framing determining component 118 may determine inverse stabilized framing information by referencing quaternions that describe rotation for individual frames of the video over the progress length.

In some examples, the initial adjustment determining component 120 may be configured as or otherwise support a means for determining initial framing adjustment information by smoothing the inverse stabilized framing information over the progress length of the video. In some implementations, the initial adjustment determining component 120 may smooth the inverse stabilized framing information by applying filtering techniques, such as bandpass filtering, to isolate specific frequency ranges of rotational motion. In some implementations, the initial adjustment determining component 120 may smooth the inverse stabilized framing information by applying amplitude limiting functions to reduce the impact of abrupt rotational changes during the progress length of the video. In some implementations, the initial adjustment determining component 120 may smooth the inverse stabilized framing information by separately processing rotational degrees of freedom, such as yaw, pitch, and roll, to account for distinct motion characteristics in each axis.

In some examples, the compensation mitigation obtaining component 122 may be configured as or otherwise support a means for obtaining a level of compensation mitigation. In some implementations, the compensation mitigation obtaining component 122 may determine the level of compensation mitigation based on user input received through a graphical user interface, such as a slider or toggle control. In some implementations, the compensation mitigation obtaining component 122 may determine the level of compensation mitigation by referencing pre-configured settings stored in a memory module associated with the system. In some implementations, the compensation mitigation obtaining component 122 may determine the level of compensation mitigation by analyzing metainformation associated with the video, such as motion intensity information, to suggest an appropriate level of adjustment.

In some examples, the final adjustment determining component 124 may be configured as or otherwise support a means for determining final framing adjustment information by applying the level of compensation mitigation to the initial framing adjustment information. In some implementations, the final adjustment determining component 124 may determine final framing adjustment information by applying a user-selected intensity parameter to adjust the degree of motion reintroduction. In some implementations, the final adjustment determining component 124 may determine final framing adjustment information by referencing pre-stored profiles that may correspond to different levels of stabilization attenuation. In some implementations, the final adjustment determining component 124 may determine final framing adjustment information by interpolating between multiple sets of initial framing adjustment information to achieve a desired compensation level.

In some examples, the modified framing generating component 112 may be configured as or otherwise support a means for generating the modified framing information by applying the final framing adjustment information to the stabilized framing information. In some implementations, the modified framing generating component 112 may determine the modified framing information by combining quaternion-based rotational information from the final framing adjustment information with stabilized framing information to adjust the viewing window orientation. In some implementations, the modified framing generating component 112 may determine the modified framing information by applying a weighted interpolation process to blend the final framing adjustment information with the stabilized framing information, where the weights may correspond to user-selected parameters. In some implementations, the modified framing generating component 112 may determine the modified framing information by referencing pre-configured motion profiles stored in a memory module to align the final framing adjustment information with stabilized framing information.

In some examples, the inverse framing determining component 118 may be configured as or otherwise support a means for determining inverse stabilized framing information that may include quaternions describing rotation for individual frames of the video over the progress length of the video. In some implementations, the inverse framing determining component 118 may determine inverse stabilized framing information by referencing spherical video information captured during the progress length to identify rotational changes in the capture reference frame. In some implementations, the inverse framing determining component 118 may determine inverse stabilized framing information by accessing metainformation associated with the video frames to extract orientation details for individual frames.

In some examples, the rotational smoothing component 126 may be configured as or otherwise support a means for smoothing the inverse stabilized framing information over the progress length of the video, wherein smoothing may include deriving, from the quaternions, separate angle of rotation functions describing rotation in individual ones of the at least two or more rotational degrees of freedom as a function of progress through the progress length of the video. In some implementations, the rotational smoothing component 126 may determine angle of rotation functions by referencing raw orientation information stored during the capture duration to identify rotational changes in the capture reference frame. In some implementations, the rotational smoothing component 126 may determine angle of rotation functions by applying mathematical operations to extract rotational information for individual frames of the video.

In some examples, the rotational smoothing component 126 may be configured as or otherwise support a means for generating smoothed angle of rotation functions for the individual ones of the at least two rotational degrees of freedom by separately smoothing the angle of rotation functions as a function of progress through the progress length of the video. In some implementations, the rotational smoothing component 126 may determine smoothed angle of rotation functions by applying bandpass filtering techniques to isolate specific frequency ranges of rotational motion. In some implementations, the rotational smoothing component 126 may determine smoothed angle of rotation functions by applying amplitude limiting functions to reduce the impact of abrupt rotational changes during the progress length of the video.

In some examples, the rotational smoothing component 126 may be configured as or otherwise support a means for deriving smoothed quaternions from the smoothed angle of rotation functions. In some implementations, the rotational smoothing component 126 may determine smoothed quaternions by referencing the smoothed angle of rotation functions to align rotational information across multiple degrees of freedom. In some implementations, the rotational smoothing component 126 may determine smoothed quaternions by applying geometric transformations to ensure consistency in rotational information across the progress length of the video.

In some examples, the rotational smoothing component 126 may be configured as or otherwise support a means for generating smoothing of the angle of rotation functions that may include bandpass filtering and/or an amplitude limiting function to the separate angle of rotation functions. In some implementations, the rotational smoothing component 126 may determine bandpass filtering parameters by referencing motion sensor information to isolate specific rotational frequencies associated with intentional camera movements. In some implementations, the rotational smoothing component 126 may apply amplitude limiting functions to reduce the impact of abrupt rotational spikes that may occur during high-speed camera movements.

In some implementations, the rotational smoothing component 126 may determine smoothing techniques by analyzing rotational information across multiple frames to identify consistent motion patterns. In some implementations, the rotational smoothing component 126 may apply customized filtering profiles that may be tailored to specific rotational degrees of freedom, such as yaw or pitch. In some implementations, the rotational smoothing component 126 may determine smoothing operations by referencing pre-configured settings stored in a memory module associated with the system.

In some examples, the initial adjustment determining component 120 may be configured as or otherwise support a means for determining initial framing adjustment information that may include the smoothed quaternions. In some implementations, the initial adjustment determining component 120 may determine smoothed quaternions by referencing rotational information stored during the capture duration to align motion trends across multiple frames. In some implementations, the initial adjustment determining component 120 may determine smoothed quaternions by applying geometric transformations to rotational information to ensure consistency in orientation across the progress length of the video. In some implementations, the initial adjustment determining component 120 may determine smoothed quaternions by processing angle of rotation functions separately for yaw, pitch, and roll to account for distinct motion characteristics in each rotational degree of freedom.

In some examples, the spherical interpolation applying component 128 may be configured as or otherwise support a means for determining the final framing adjustment information by applying a spherical linear interpolation operation to the smoothed quaternions, wherein the level of compensation mitigation may determine a parameter of the spherical linear interpolation operation applied to the smoothed quaternions. In some implementations, the spherical interpolation applying component 128 may determine the parameter by referencing user input received through a graphical interface, such as a slider control that may adjust the intensity of motion reintroduction. In some implementations, the spherical interpolation applying component 128 may determine the parameter by accessing pre-configured settings stored in a memory module that may correspond to different levels of stabilization attenuation. In some implementations, the spherical interpolation applying component 128 may determine the parameter by analyzing metainformation associated with the video, such as motion intensity information, to suggest an appropriate interpolation level.

In some examples, the stabilized framing obtaining component 110 may be configured as or otherwise support a means for obtaining stabilized framing information that may compensate for relative rotation between the capture reference frame and the global reference frame in the at least two rotational degrees of freedom during the capture duration, wherein the compensation may significantly reduce or effectively eliminate relative rotation of the viewing window with respect to the global reference frame in the at least two rotational degrees of freedom. In some implementations, the stabilized framing obtaining component 110 may determine stabilized framing information by referencing motion sensor information, such as gyroscope outputs, to determine and/or track changes in pitch and roll during the capture duration. In some implementations, the stabilized framing obtaining component 110 may determine stabilized framing information by analyzing the orientation of the viewing window relative to a global reference frame to maintain consistent alignment in pitch and roll. In some implementations, the stabilized framing obtaining component 110 may determine stabilized framing information by applying filtering techniques to smooth abrupt changes in pitch and roll orientation over the progress length of the video.

In some examples, the video information obtaining component 108 may be configured as or otherwise support a means for obtaining video information that may include the stabilized framing information. In some implementations, the video information obtaining component 108 may determine stabilized framing information by referencing spherical video information captured during the progress length to identify rotational changes in the capture reference frame. In some implementations, the video information obtaining component 108 may determine stabilized framing information by accessing metainformation associated with the video frames to extract orientation details for individual frames.

In some examples, the stabilized framing obtaining component 110 may be configured as or otherwise support a means for obtaining stabilized framing information that may be derived from orientation information generated by one or more motion sensors of the image capture device. In some implementations, the stabilized framing obtaining component 110 may determine stabilized framing information by referencing gyroscope information to track rotational changes during the capture duration. In some implementations, the stabilized framing obtaining component 110 may determine stabilized framing information by accessing accelerometer outputs to identify tilt or inclination of the image capture device relative to a reference axis. In some implementations, the stabilized framing obtaining component 110 may determine stabilized framing information by combining orientation information from multiple motion sensors to account for complex rotational movements.

In some implementations, computing platform(s) 102, remote platform(s) 104, and/or external resources 130 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 130 may be operatively linked via some other communication media.

A given remote platform may include one or more processors configured to execute computer program components. The computer program components may be configured to enable an expert or user associated with the given remote platform to interface with system 100 and/or external resources 130, and/or provide other functionality attributed herein to remote platform(s) 104. By way of non-limiting example, a given remote platform and/or a given computing platform may include one or more of a smart card, a server, a desktop computer, a laptop computer, a handheld computer, a tablet computing platform, a NetBook, a Smartphone, a gaming console, and/or other computing platforms. In some implementations, the computing platform(s) 102 may comprise server(s), and the remote platform(s) 104 may comprise remotely located client computing platform(s).

External resources 130 may include sources of information outside of system 100, external entities participating with system 100, and/or other resources. In some implementations, some or all of the functionality attributed herein to external resources 130 may be provided by resources included in system 100.

Computing platform(s) 102 may include electronic storage 132, one or more processors 134, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 132 may comprise non-transitory storage media that electronically stores information. The electronic storage media of electronic storage 132 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from computing platform(s) 102, information received from remote platform(s) 104, and/or other information that enables computing platform(s) 102 to function as described herein.

Processor(s) 134 may be configured to provide information processing capabilities in computing platform(s) 102. As such, processor(s) 134 may include one or more of a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. Processor(s) 134 may be configured to execute components 108, 110, 112, 114, 116, 118, 120, 122, 124, 126, 128, and/or other components. Processor(s) 134 may be configured to execute components 108, 110, 112, 114, 116, 118, 120, 122, 124, 126, 128, and/or other components by software; hardware; firmware; some combination of software, hardware, and/or firmware; and/or other mechanisms for configuring processing capabilities on processor(s) 134. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 122, 124, 126, and/or 128 are illustrated in FIG. 1 as being implemented within a single processing unit, in implementations in which processor(s) 134 includes multiple processing units, one or more of components 108, 110, 112, 114, 116, 118, 120, 122, 124, 126, and/or 128 may be implemented remotely from the other components. The description of the functionality provided by the different components 108, 110, 112, 114, 116, 118, 120, 122, 124, 126, and/or 128 described below is for illustrative purposes, and is not intended to be limiting, as any of components 108, 110, 112, 114, 116, 118, 120, 122, 124, 126, and/or 128 may provide more or less functionality than is described. For example, one or more of components 108, 110, 112, 114, 116, 118, 120, 122, 124, 126, and/or 128 may be eliminated, and some or all of its functionality may be provided by other ones of components 108, 110, 112, 114, 116, 118, 120, 122, 124, 126, and/or 128. As another example, processor(s) 134 may be configured to execute one or more additional components that may perform some or all of the functionality attributed below to one of components 108, 110, 112, 114, 116, 118, 120, 122, 124, 126, and/or 128.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

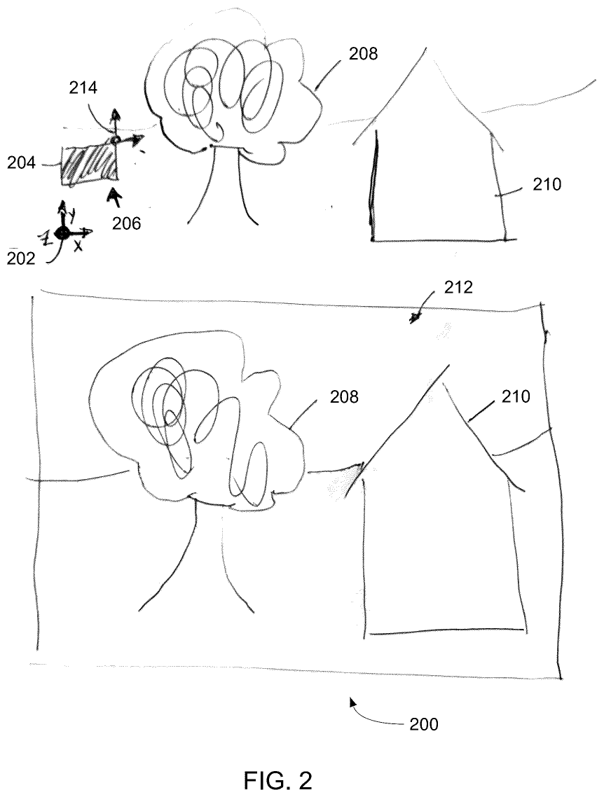

FIG. 2 is a diagram which illustrates concepts relevant to mitigating stabilization effects to restore natural motion in video framing in accordance with various aspects of the present disclosure. As depicted in FIG. 2, the labeled diagram sketch 200 may include one or more of translational axis 202, image capture device 204, initial translational position 206, first object (tree) 208, second object (building) 210, visual content 212, capture reference frame axis 214, and/or other components.

The translational axis 202 may represent the XYZ coordinates of the environment in which the image capture device operates. The translational axis 202 may define a global reference frame that remains static during the capture duration of the video. The translational axis 202 may include three orthogonal axes corresponding to the directions sometimes referred to as surge, sway, and heave. In some implementations, the translational axis 202 may be used to determine the relative motion of the image capture device 204 during video capture. The translational axis 202 may be represented visually in diagrams as a set of labeled axes, such as X, Y, and Z, to illustrate the spatial orientation of the environment.

The image capture device 204 may include a camera or similar device capable of capturing visual content during motion. The image capture device 204 may be equipped with motion sensors, such as gyroscopes and accelerometers, to record orientation and movement information during the capture duration. The image capture device 204 may include components such as an image sensor, a lens assembly, and a housing that anchors the capture reference frame axis 214. In some implementations, the image capture device 204 may be used to record spherical video content, such as 360-degree footage, by employing dual opposing lenses. The image capture device 204 may be portable and may be operated in dynamic environments, such as during sports or outdoor activities.

The initial translational position 206 may represent the starting physical location of the image capture device within the global reference frame. The initial translational position 206 may be determined based on the coordinates of the translational axis 202 at the beginning of the capture duration. The initial translational position 206 may serve as a reference point for tracking the displacement of the image capture device 204 during motion. In some implementations, the initial translational position 206 may be visually represented in diagrams as a labeled point on the translational axis 202. The initial translational position 206 may correspond to the location of the image capture device 204 before any translational motion occurs.

The first object (tree) 208 may represent a static object within the scene captured by the image capture device. The first object (tree) 208 may remain stationary with respect to the global reference frame during the capture duration. The first object (tree) 208 may appear in the visual content 212 at specific coordinates within the viewing window defined by the capture reference frame axis 214. In some implementations, the first object (tree) 208 may be used to illustrate the parallax effect caused by translational motion of the image capture device 204. The first object (tree) 208 may be closer to the image capture device 204 than the second object (building) 210, resulting in greater perceived displacement within the visual content 212.

The second object (building) 210 may represent another static object within the scene captured by the image capture device. The second object (building) 210 may remain stationary with respect to the global reference frame during the capture duration. The second object (building) 210 may appear in the visual content 212 at specific coordinates within the viewing window defined by the capture reference frame axis 214. In some implementations, the second object (building) 210 may be used to illustrate the relative motion of objects at different depths within the scene. The second object (building) 210 may be farther from the image capture device 204 than the first object (tree) 208, resulting in less perceived displacement within the visual content 212.

The capture reference frame axis 214 may represent the axis anchored to and moving with the image capture device during video capture. The capture reference frame axis 214 may define the orientation of the viewing window relative to the global reference frame. The capture reference frame axis 214 may rotate in three rotational degrees of freedom—yaw, pitch, and roll—during the capture duration. In some implementations, the capture reference frame axis 214 may be visually represented in diagrams as a labeled axis fixed to the image capture device 204. The capture reference frame axis 214 may be used to determine the relative rotation of the image capture device 204 with respect to the global reference frame.

The visual content 212 may include the portion of the scene framed by the viewing window of the image capture device. The presentation of the visual content 212 may be defined by the stabilized framing information, which compensates for rotational motion of the image capture device 204 during the capture duration. The visual content 212 may include static objects, such as the first object (tree) 208 and the second object (building) 210, as well as dynamic elements within the scene. In some implementations, the visual content 212 may be presented as spherical video content, encompassing the entire capture environment. The visual content 212 may be displayed within a modified viewing window that reflects a controlled amount of the original motion of the image capture device 204.

In some implementations, the translational axis 202 may define the movement of the image capture device 204 relative to the initial translational position 206, which may serve as a reference point for determining positional changes during video capture. The first object 208, which may represent a tree, and the second object 210, which may represent a building, may be positioned within the visual content 212 captured by the image capture device 204. The capture reference frame axis 214 may align with the translational axis 202 to establish a coordinate system for interpreting the spatial relationship between the image capture device 204 and the visual content 212.

In some implementations, the image capture device 204 may record rotational and translational motion information relative to the capture reference frame axis 214, which may include the orientation and position of the device during the video capture duration. The visual content 212 may encompass the spatial arrangement of the first object 208 and the second object 210 within the viewing window defined by the stabilized framing information. The initial translational position 206 may serve as a baseline for determining changes in the translational axis 202, which may influence the framing adjustment information applied during post-capture processing.

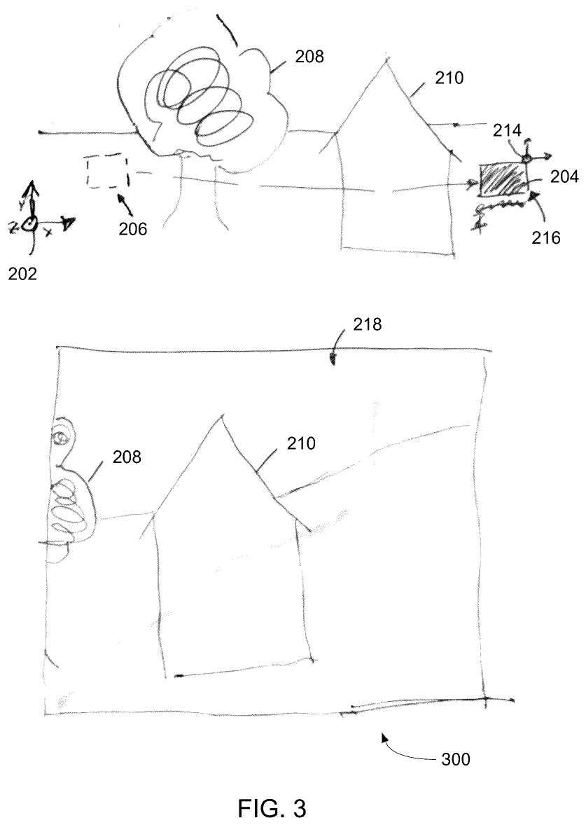

FIG. 3 shows a diagram that illustrates aspects relevant to mitigating stabilization effects to restore natural motion in video framing in accordance with various aspects of the present disclosure. As depicted in FIG. 3, the sketch with labels 300 may include one or more of first object (tree) 208, second object (building) 210, translational axis 202, image capture device 204, initial translational position 206, capture reference frame axis 214, displaced translational position 216, visual content 218, and/or other components.

The first object (tree) 208 may represent a static element within the scene captured by the image capture device 204. In some implementations, the first object (tree) 208 may be the same as or similar to the first object (tree) 208, as described herein.

The second object (building) 210 may include another static element positioned within the environment defined by the translational axis 202. In some implementations, the second object (building) 210 may be the same as or similar to the second object (building) 210, as described herein.

The translational axis 202 may define the global reference frame for the environment, including the x, y, and z coordinates. In some implementations, the translational axis 202 may be the same as or similar to the translational axis 202, as described herein.

The image capture device 204 may include a device capable of capturing visual content while undergoing translational motion within the global reference frame. In some implementations, the image capture device 204 may be the same as or similar to the image capture device 204, as described herein.

The initial translational position 206 may represent the starting physical location of the image capture device 204 within the global reference frame. In some implementations, the initial translational position 206 may be the same as or similar to the initial translational position 206, as described herein.

The capture reference frame axis 214 may include an axis anchored to the image capture device 204, moving with the device during translational motion. The capture reference frame axis 214 may be defined relative to the orientation and position of the image capture device 204. The capture reference frame axis 214 may allow for the determination of the relative motion of the image capture device 204 with respect to the global reference frame defined by the translational axis 202. In some implementations, the capture reference frame axis 214 may be used to describe the rotational orientation of the image capture device 204 during the capture duration.

The displaced translational position 216 may represent the new physical location of the image capture device 204 after experiencing translational motion along the translational axis 202. The displaced translational position 216 may be determined based on the movement of the image capture device 204 relative to the initial translational position 206. The displaced translational position 216 may correspond to a change in the coordinates of the image capture device 204 within the global reference frame defined by the translational axis 202. In some implementations, the displaced translational position 216 may be used to determine the relative displacement of objects within the visual content 218.

The visual content 218 may include the scene captured by the image capture device 204, framed within the viewing window associated with the capture reference frame axis 214. In some implementations, the visual content 218 may be the same as or similar to the visual content 212, as described herein. Specifically, the visual content 218 may reflect the parallax or positional shift of the first object 208 and second object 210 resulting from the movement to the displaced translational position 216.

In some implementations, the image capture device 204 may be positioned at an initial translational position 206 along the translational axis 202, which may define the spatial relationship between the first object 208 and the second object 210. The capture reference frame axis 214 may align with the orientation of the image capture device 204 during the initial capture, while the displaced translational position 216 may represent a shift in the device's position relative to the translational axis 202. The visual content 218 may correspond to the subset of spherical video content captured within the viewing window defined by the stabilized framing information.

In some implementations, the first object 208 and the second object 210 may serve as reference points within the visual content 218, allowing the system to determine the relative motion of the image capture device 204 along the translational axis 202. The initial translational position 206 may establish the baseline spatial configuration, while the displaced translational position 216 may reflect changes in the device's position during the capture duration. The capture reference frame axis 214 may be used to determine rotational motion, which may influence the stabilized framing information and subsequent modifications applied to the viewing window.

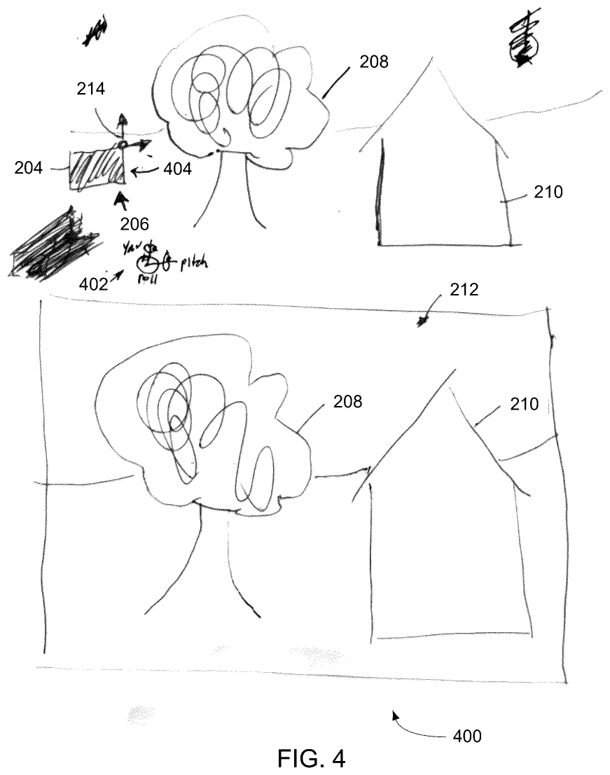

FIG. 4 is a diagram 400 illustrates concepts relevant to mitigating stabilization effects to restore natural motion in video framing in accordance with various aspects of the present disclosure. As depicted in FIG. 4, the tree house diagram 400 may include one or more of rotational axis 402, image capture device 204, initial translational position 206, first object (tree) 208, second object (building) 210, capture reference frame axis 214, initial rotational position 404, visual content 212, and/or other components.

The rotational axis 402 may represent the orientation framework encompassing three rotational degrees of freedom, including yaw, pitch, and roll. The rotational axis 402 may be defined relative to a global reference frame, which may serve as a fixed coordinate system for determining the orientation of other components. The rotational axis 402 may interact with the image capture device 204 to track its orientation changes during motion. In some implementations, the rotational axis 402 may be used to determine the relative rotation of the capture reference frame axis 214 with respect to the global reference frame.

The image capture device 204 may include hardware capable of recording video content while experiencing motion in multiple degrees of freedom. In some implementations, the image capture device 204 may be the same as or similar to the image capture device 204 described herein.

The initial translational position 206 may represent the starting physical location of the image capture device 204 within the global reference frame. The initial translational position 206 may be defined by the coordinates of the image capture device 204 along the translational axis 202 at the beginning of the capture duration. The initial translational position 206 may be used to determine the relative displacement of the image capture device 204 during translational motion. In some implementations, the initial translational position 206 may be used in conjunction with the displaced translational position 216 to determine the magnitude and direction of translational motion.

The first object (tree) 208 may represent a static element within the scene captured by the image capture device 204. In some implementations, the first object (tree) 208 may be the same as or similar to the first object (tree) 208 described herein.

The second object (building) 210 may represent another static element within the scene captured by the image capture device 204. In some implementations, the second object (building) 210 may be the same as or similar to the second object (building) 210 described herein.

The capture reference frame axis 214 may represent the axis anchored to the image capture device 204, moving in alignment with its orientation. In some implementations, the capture reference frame axis 214 may be the same as or similar to the capture reference frame axis 214 described herein.

The initial rotational position 404 may represent the starting orientation of the image capture device 204 relative to the rotational axis 402. The initial rotational position 404 may be defined by the alignment of the capture reference frame axis 214 with respect to the rotational axis 402 at the beginning of the capture duration. The initial rotational position 404 may be used to determine the relative rotation of the image capture device 204 during the capture duration. In some implementations, the initial rotational position 404 may be used in conjunction with the rotated rotational position to determine the angular displacement of the image capture device 204.

The visual content 212 may include the portion of the scene framed within the viewing window during video capture. In some implementations, the visual content 212 may be the same as or similar to the visual content 212 and/or the visual content 218 described herein.

In some implementations, the image capture device 204 may be positioned at an initial translational position 206 and oriented along an initial rotational position 404 relative to the rotational axis 402. The capture reference frame axis 214 may define the orientation of the image capture device 204 during video capture, allowing rotational motion to be tracked in three degrees of freedom, including yaw, pitch, and roll. The visual content 212 may include a first object, such as a tree 208, and a second object, such as a building 210, which may be located at different positions within the scene relative to the initial translational position 206 of the image capture device 204.

In some implementations, the rotational axis 402 may serve as a reference for determining the orientation of the image capture device 204 as it moves relative to the global reference frame. The visual content 212 captured by the image capture device 204 may shift within the viewing window as the device undergoes rotational motion, with the capture reference frame axis 214 serving to align the stabilized framing information with the global reference frame. The first object 208 and the second object 210 may appear in different positions within the viewing window depending on the rotational and translational motion of the image capture device 204, as well as the modified framing information generated during post-capture processing.

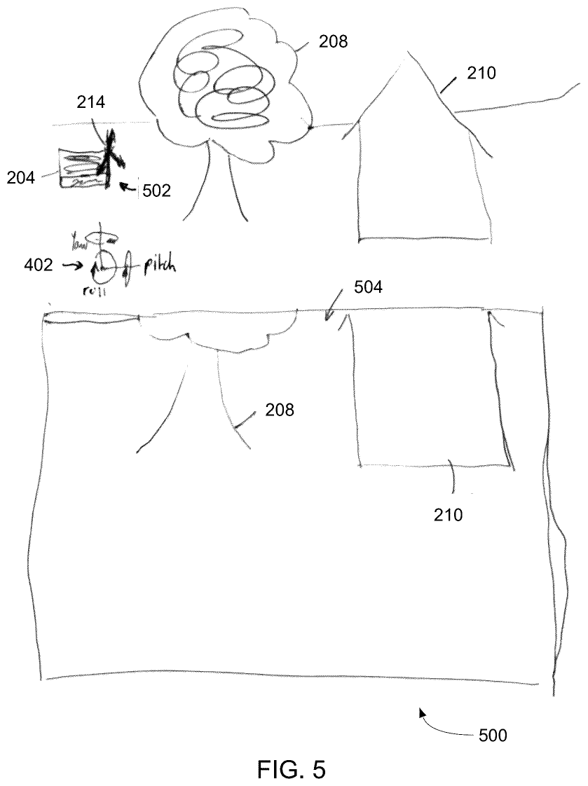

FIG. 5 shows a diagram illustrating concepts relevant to mitigating stabilization effects to restore natural motion in video framing in accordance with various aspects of the present disclosure. As depicted in FIG. 5, the outdoor scene diagram 500 may include one or more of image capture device 204, first object (tree) 208, second object (building) 210, capture reference frame axis 214, rotational axis 402, rotated rotational position 502, visual content 504, and/or other components.

The image capture device 204 may include sensors capable of detecting rotational motion during video capture. In some implementations, the image capture device 204 may be the same as or similar to the image capture device 204, as described herein.

The first object (tree) 208 may represent a static element within the outdoor scene. In some implementations, the first object (tree) 208 may be the same as or similar to the first object (tree) 208, as described herein.

The second object (building) 210 may represent another static element positioned at a different depth in the outdoor scene. In some implementations, the second object (building) 210 may be the same as or similar to the second object (building) 210, as described herein.

The capture reference frame axis 214 may define the orientation of the image capture device 204 during video capture. In some implementations, the capture reference frame axis 214 may be the same as or similar to the capture reference frame axis 214, as described herein.

The rotational axis 402 may represent the global reference frame encompassing three rotational degrees of freedom. In some implementations, the rotational axis 402 may be the same as or similar to the rotational axis 402, as described herein.

The rotated rotational position 502 may indicate the orientation of the image capture device 204 after experiencing rotational motion. The rotated rotational position 502 may be determined based on the relative rotation of the image capture device 204 with respect to the global reference frame. The rotated rotational position 502 may include information about the yaw, pitch, and roll of the image capture device 204 during the capture duration. The rotated rotational position 502 may be used to determine changes in the viewing window orientation relative to the global reference frame. In some implementations, the rotated rotational position 502 may be represented as quaternions describing the rotation of the image capture device 204.

The visual content 504 may include the perceived positions of the first object (tree) 208 and the second object (building) 210 within the viewing window. In some implementations, the visual content 504 may be the same as or similar to the visual content 212, as described herein, but reflecting the displacement caused by the rotation.

In some implementations, the image capture device 204 may be positioned relative to the first object 208, which may represent a tree, and the second object 210, which may represent a building, to capture visual content 504 within a defined viewing window. The capture reference frame axis 214 may align with the orientation of the image capture device 204 during video capture, serving as a baseline for determining rotational motion. The rotational axis 402 may correspond to one of the three degrees of freedom—yaw, pitch, or roll—captured by the device's motion sensors, and the rotated rotational position 502 may represent the physical orientation of the device that the system tracks to generate orientation information.

In some implementations, the visual content 504 may be dynamically extracted from the spherical video content based on the framing information. The rotational axis 402 may interact with the capture reference frame axis 214 to determine the relative orientation of the viewing window. The rotated rotational position 502 illustrates a physical rotation (e.g., pitch) that results in a corresponding vertical shift of the first object 208 and the second object 210 within the visual content 504 if not compensated for. This shift serves as the reference for determining the separate rotational degrees of freedom that may require stabilization or smoothing during post-capture processing.

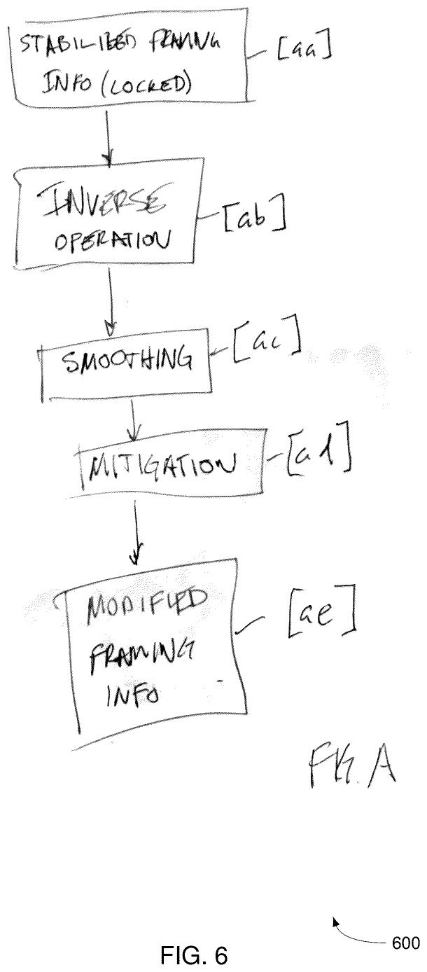

FIG. 6 illustrates a flowchart 600 that supports techniques for mitigating stabilization effects to restore natural motion in video framing in accordance with various aspects of the present disclosure. Operations illustrated in the flowchart 600 may involve stabilized framing information, an inverse operation logic block, a smoothing/filter block, a mitigation level input, and/or modified framing information, which may be examples of corresponding devices described herein. The flowchart 600 may describe a process for obtaining stabilized framing information, applying an inverse operation, smoothing the information, mitigating stabilization effects, and generating modified framing information.

At 602, the stabilized framing information may include information defining a viewing window orientation relative to a global reference frame. In some implementations, the stabilized framing information may define the orientation of the viewing window in terms of yaw, pitch, and roll relative to the global reference frame. The stabilized framing information may be derived from motion sensor information collected during the capture duration of the video. The stabilized framing information may include adjustments that compensate for rotational motion of the image capture device during video recording. The stabilized framing information may be stored in a memory unit for subsequent processing.

At 604, the logic determines the adjustment information to be injected into the stabilization. In some implementations, this involves an inverse operation to determine raw rotational motion information by reversing the stabilized framing information. For example, where the stabilized framing information comprises a sequence of quaternions defining the locked viewing window, the system may derive the conjugate or inverse of those quaternions to recover the motion that was removed. This recovered motion effectively serves as the “noise” or “jitter” signal source for the subsequent injection process. However, in other implementations, the noise source may be derived from other motion profiles, procedural generation, alternative sensor information, or other sources.

At 606, the smoothing/filter block may apply filtering techniques to remove high-frequency jitter from the raw rotational motion. In some implementations, the smoothing/filter block may apply bandpass filtering to isolate lower-frequency motion trends from the raw rotational motion information. The smoothing/filter block may determine smoothed angle of rotation functions for individual rotational degrees of freedom, such as yaw, pitch, and roll. The smoothing/filter block may limit the amplitude of high-frequency components in the raw rotational motion information to reduce jitter. The smoothing/filter block may output smoothed quaternions that represent the refined rotational motion information.

At 608, the mitigation level input may determine the degree of compensation adjustment applied to the smoothed motion information. In some implementations, the mitigation level input may be a user-selectable control variable that specifies the intensity of compensation adjustment. The mitigation level input may determine a parameter for spherical linear interpolation applied to the smoothed quaternions. The mitigation level input may be provided through a user interface, such as a touchscreen or physical buttons. The mitigation level input may influence the final framing adjustment information generated by the system.

At 610, the modified framing information is generated. This operation may include mathematically combining the stabilized framing information (the baseline locked view) with the final framing adjustment information (the smoothed/attenuated motion). In implementations utilizing quaternions, this combination is performed via quaternion multiplication. For example, for a given frame, the stabilized quaternion is multiplied by the adjustment quaternion. The resulting product defines a new viewing window orientation that retains the general stability of the baseline but “drifts” or “banks” according to the smoothed motion profile, thereby achieving the attenuated compensation recited in the claims.

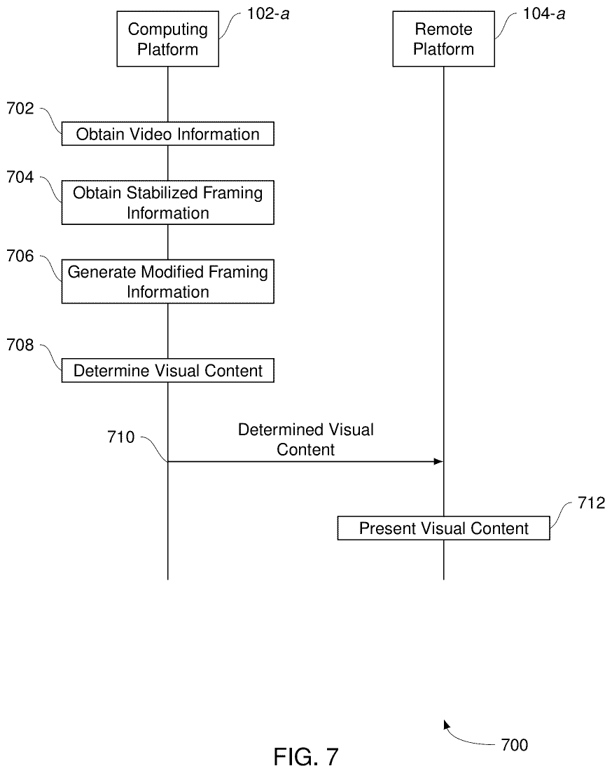

FIG. 7 illustrates an example of a process flow 700 for mitigating stabilization effects to restore natural motion in video framing in accordance with aspects of the present disclosure. In some examples, the process flow 700 may implement aspects of the system 100. For example, the process flow 700 may include a computing platform 102-a (e.g., a server) and a remote platform 104-a (e.g., a user device), which may be examples of corresponding devices described herein. In some implementations, a computing platform 102-a obtains video information and stabilized framing information, generates modified framing information by attenuating rotation compensation using a noise injection process, determines visual content within the modified viewing window, and transmits the visual content to a remote platform 104-a for presentation as a function of progress through the video.

At 702, the computing platform 102-a may obtain video information defining a video, the video may have a progress length, the video may include visual content viewable as a function of progress through the progress length, the video may be captured by an image capture device over a capture duration in a capture reference frame associated with the image capture device, wherein during the capture duration the image capture device may rotate in three rotational degrees of freedom with respect to a global reference frame of the visual content, thereby causing corresponding rotation between the capture reference frame and the global reference frame in the three rotational degrees of freedom. For example, the video information may include stabilized framing information that defines a viewing window orientation compensating for relative rotation between the capture reference frame and the global reference frame. In some implementations, the video information may include raw orientation information generated by motion sensors of the image capture device, such as gyroscopes and accelerometers, during the capture duration. In some implementations, the video information may include metainformation describing the rotational degrees of freedom experienced by the image capture device during the capture duration.

At 704, the computing platform 102-a may obtain stabilized framing information that defines a viewing window of the visual content for presentation as a function of progress through the progress length of the video, wherein the framing information may include viewing window orientation information that may define rotation of the viewing window with respect to the capture reference frame in at least two of the rotational degrees of freedom as a function of progress through the progress length that may compensate for relative rotation between the capture reference frame and the global reference frame in the at least two rotational degrees of freedom during the capture duration. For example, the stabilized framing information may include horizon-locking information that may maintain the viewing window level with respect to the global reference frame in pitch and roll while allowing yaw to remain responsive to camera movements. In some implementations, the stabilized framing information may define direction-locking information that may stabilize the viewing window across all three rotational degrees of freedom, ensuring the viewing window orientation remains fixed on a specific coordinate within the global reference frame throughout the progress length of the video. In some implementations, the stabilized framing information may be derived from orientation information generated by motion sensors, such as gyroscopes and accelerometers, embedded in the image capture device during the capture duration.

At 706, the computing platform 102-a may generate modified framing information that defines a modified viewing window of the visual content for presentation as a function of progress through the progress length of the video, wherein the modified framing information may attenuate compensation for relative rotation between the capture reference frame and the global reference frame provided by the stabilized framing information in the at least two rotational degrees of freedom, where the modified framing information may be derived from the stabilized framing information with a noise injection process. For example, the computing platform 102-a may determine inverse stabilized framing information to recover raw rotational motion information from the capture duration and apply smoothing operations to remove high-frequency jitter while preserving lower-frequency motion trends. In some implementations, the computing platform 102-a may apply a user-selectable control input to adjust the level of compensation mitigation, which may influence the degree of motion reintroduced into the modified viewing window. In some implementations, the modified framing information may be represented as quaternions describing rotation for individual frames of the video, which may be combined with the stabilized framing information to define the final viewing window orientation.

At 708, the computing platform 102-a may determine the visual content within the viewing window defined by the modified framing information as a function of progress through the progress length of the video. For example, the computing platform 102-a may analyze the modified framing information to identify specific portions of the visual content that correspond to user-defined parameters, such as areas of interest or motion trends. In some implementations, the computing platform 102-a may apply frame-by-frame adjustments to the viewing window orientation based on the modified framing information to ensure the visual content aligns with the intended motion profile. In some implementations, the computing platform 102-a may process metainformation associated with the video to refine the visual content selection within the viewing window, such as by referencing depth information or object tracking information.

At 710, the computing platform 102-a may transmit the determined visual content to the remote platform 104-a for presentation as a function of progress through the progress length of the video. For example, the computing platform 102-a may transmit the visual content through a wireless communication module, such as Wi-Fi or Bluetooth, to the remote platform 104-a. In some implementations, the computing platform 102-a may encode the visual content into a specific format, such as MP4 or H.265, before transmitting it to the remote platform 104-a. In some implementations, the computing platform 102-a may transmit metainformation alongside the visual content, such as timestamp information or viewing window orientation information, to the remote platform 104-a.

At 712, the remote platform 104-a may present the visual content determined to be within the viewing window defined by the modified framing information as a function of progress through the progress length of the video. For example, the remote platform 104-a may display the visual content on a touchscreen interface, allowing a user to interact with the video playback by adjusting the viewing window orientation. In some implementations, the remote platform 104-a may stream the visual content to an external display device, such as a television or projector, through a wireless connection module. In some implementations, the remote platform 104-a may overlay metainformation, such as timestamps or motion trend indicators, onto the visual content during presentation.

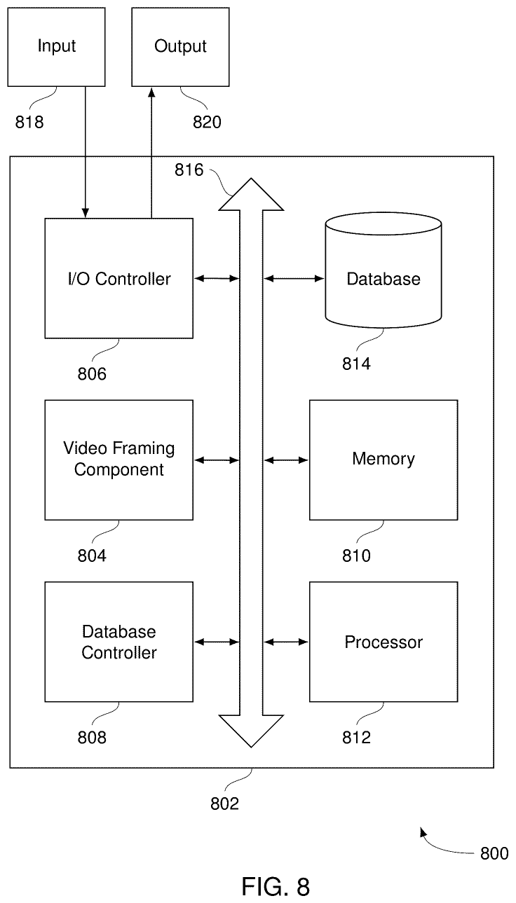

FIG. 8 shows a diagram of a system 800 including a device 802 configured for mitigating stabilization effects to restore natural motion in video framing in accordance with aspects of the present disclosure. The device 802 may be an example of or include the components of a computing platform 102 and a remote platform 104 as described herein. The device 802 may include components for bi-directional information communications including components for transmitting and receiving communications, including a video framing component 804, an I/O controller 806, a informationbase controller 808, memory 810, a processor 812, and a informationbase 814. These components may be in electronic communication via one or more buses (e.g., bus 816).

The video framing component 804 may be an example of one or more components of the system 100 as described herein. For example, the video framing component 804 may perform any of the methods or processes described above with reference to machine-readable instructions 106 in connection with FIG. 1. In some cases, the video framing component 804 may be implemented in hardware, software executed by a processor, firmware, or any combination thereof.

The I/O controller 806 may manage input signals 818 and output signals 8130 for the device 802. The I/O controller 806 may also manage peripherals not integrated into the device 802. In some cases, the I/O controller 806 may represent a physical connection or port to an external peripheral. In some cases, the I/O controller 806 may utilize an operating system such as iOS®, ANDROID®, MS-DOS®, MS-WINDOWS®, OS/2®, UNIX®, LINUX®, or another known operating system. In other cases, the I/O controller 806 may represent or interact with a modem, a keyboard, a mouse, a touchscreen, or a similar device. In some cases, the I/O controller 806 may be implemented as part of a processor. In some cases, a user may interact with the device 802 via the I/O controller 806 or via hardware components controlled by the I/O controller 806.

The informationbase controller 808 may manage information storage and processing in a informationbase 814. In some cases, a user may interact with the informationbase controller 808. In other cases, the informationbase controller 808 may operate automatically without user interaction. The informationbase 814 may be an example of a single informationbase, a distributed informationbase, multiple distributed informationbases, a information store, a information lake, or an emergency backup informationbase.

Memory 810 may include random-access memory (RAM) and read-only memory (ROM). The memory 810 may store computer-readable, computer-executable software including instructions that, when executed, cause the processor to perform various functions described herein. In some cases, the memory 810 may contain, among other things, a basic input/output system (BIOS) which may control basic hardware or software operation such as the interaction with peripheral components or devices.

The processor 812 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 812 may be configured to operate a memory array using a memory controller. In other cases, a memory controller may be integrated into the processor 812. The processor 812 may be configured to execute computer-readable instructions stored in a memory 810 to perform various functions (e.g., functions or tasks for mitigating stabilization effects to restore natural motion in video framing).

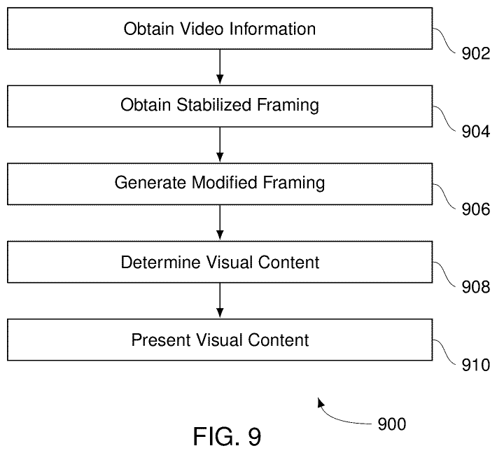

FIG. 9 shows a flowchart illustrating a method 900 for mitigating stabilization effects to restore natural motion in video framing in accordance with various aspects of the present disclosure. The operations of the method 900 may be implemented by one or more components of a networked computing system as described herein. For example, the operations of the method 900 may be performed by video framing component 804 or through execution of machine-readable instructions 106 as described with reference to FIG. 8 and FIG. 1, respectively. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 902, the method 900 may include obtaining video information defining a video, the video having a progress length, the video including visual content viewable as a function of progress through the progress length, the video captured by an image capture device over a capture duration in a capture reference frame associated with the image capture device, wherein during the capture duration the image capture device rotated in three rotational degrees of freedom with respect to a global reference frame of the visual content, thereby causing corresponding rotation between the capture reference frame and the global reference frame in the three rotational degrees of freedom. The operations of 902 may be performed in accordance with examples as disclosed herein. In some examples, aspects of the operations of 902 may be performed by a video information obtaining component 108 as described with reference to FIG. 1.

At 904, the method 900 may include obtaining stabilized framing information that defines a viewing window of the visual content for presentation as a function of progress through the progress length of the video, wherein the framing information includes viewing window orientation information that defines rotation of the viewing window with respect to the capture reference frame in at least two of the rotational degrees of freedom as a function of progress through the progress length that compensates for relative rotation between the capture reference frame and the global reference frame in the at least two rotational degrees of freedom during the capture duration. The operations of 904 may be performed in accordance with examples as disclosed herein. In some examples, aspects of the operations of 904 may be performed by a stabilized framing obtaining component 110 as described with reference to FIG. 1.

At 906, the method 900 may include generating modified framing information that defines a modified viewing window of the visual content for presentation as a function of progress through the progress length of the video, wherein the modified framing information attenuates compensation for relative rotation between the capture reference frame and the global reference frame provided by the stabilized framing information in the at least two rotational degrees of freedom, where the modified framing information is derived from the stabilized framing information with a noise injection process. The operations of 906 may be performed in accordance with examples as disclosed herein. In some examples, aspects of the operations of 906 may be performed by a modified framing generating component 112 as described with reference to FIG. 1.

At 908, the method 900 may include determining the visual content within the viewing window defined by the modified framing information as a function of progress through the progress length of the video. The operations of 908 may be performed in accordance with examples as disclosed herein. In some examples, aspects of the operations of 908 may be performed by a visual content determining component 114 as described with reference to FIG. 1.

At 910, the method 900 may include presenting the visual content determined to be within the viewing window defined by the modified framing information as a function of progress through the progress length of the video. The operations of 910 may be performed in accordance with examples as disclosed herein. In some examples, aspects of the operations of 910 may be performed by a visual content presenting component 116 as described with reference to FIG. 1.

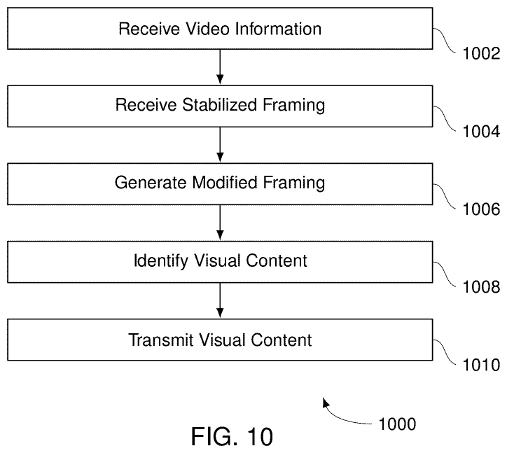

FIG. 10 shows a flowchart illustrating a method 1000 for mitigating stabilization effects to restore natural motion in video framing in accordance with various aspects of the present disclosure. The operations of the method 1000 may be implemented by one or more components of a networked computing system as described herein. For example, the operations of the method 1000 may be performed by video framing component 804 or through execution of machine-readable instructions 106 as described with reference to FIG. 8 and FIG. 1, respectively. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1002, the method 1000 may include receiving video information defining a video, the video having a progress length, the video including visual content viewable as a function of progress through the progress length, the video captured by an image capture device over a capture duration in a capture reference frame associated with the image capture device, wherein during the capture duration the image capture device rotated in three rotational degrees of freedom with respect to a global reference frame of the visual content, thereby causing corresponding rotation between the capture reference frame and the global reference frame in the three rotational degrees of freedom. The operations of 1002 may be performed in accordance with examples as disclosed herein. In some examples, aspects of the operations of 1002 may be performed by a video information obtaining component 108 as described with reference to FIG. 1.

At 1004, the method 1000 may include receiving stabilized framing information that defines a viewing window of the visual content for presentation as a function of progress through the progress length of the video, wherein the framing information includes viewing window orientation information that defines rotation of the viewing window with respect to the capture reference frame in at least two of the rotational degrees of freedom as a function of progress through the progress length that compensates for relative rotation between the capture reference frame and the global reference frame in the at least two rotational degrees of freedom during the capture duration. The operations of 1004 may be performed in accordance with examples as disclosed herein. In some examples, aspects of the operations of 1004 may be performed by a stabilized framing obtaining component 110 as described with reference to FIG. 1.

At 1006, the method 1000 may include generating modified framing information that defines a modified viewing window of the visual content for presentation as a function of progress through the progress length of the video, wherein the modified framing information attenuates compensation for relative rotation between the capture reference frame and the global reference frame provided by the stabilized framing information in the at least two rotational degrees of freedom, where the modified framing information is derived from the stabilized framing information with a noise injection process. The operations of 1006 may be performed in accordance with examples as disclosed herein. In some examples, aspects of the operations of 1006 may be performed by a modified framing generating component 112 as described with reference to FIG. 1.

At 1008, the method 1000 may include identifying the visual content within the viewing window defined by the modified framing information as a function of progress through the progress length of the video. The operations of 1008 may be performed in accordance with examples as disclosed herein. In some examples, aspects of the operations of 1008 may be performed by a visual content determining component 114 as described with reference to FIG. 1.

At 1010, the method 1000 may include transmitting the visual content identified to be within the viewing window defined by the modified framing information as a function of progress through the progress length of the video. The operations of 1010 may be performed in accordance with examples as disclosed herein. In some examples, aspects of the operations of 1010 may be performed by a visual content presenting component 116 as described with reference to FIG. 1.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, information, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or information structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce information magnetically, while discs reproduce information optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of framing videos, the method comprising:
obtaining video information defining a video, the video having a progress length, the video including visual content viewable as a function of progress through the progress length, the video captured by an image capture device over a capture duration in a capture reference frame associated with the image capture device, wherein during the capture duration the image capture device rotated in three rotational degrees of freedom with respect to a global reference frame of the visual content, thereby causing corresponding rotation between the capture reference frame and the global reference frame in the three rotational degrees of freedom,
obtaining stabilized framing information that defines a viewing window of the visual content for presentation as a function of progress through the progress length of the video, wherein the framing information includes viewing window orientation information that defines rotation of the viewing window with respect to the capture reference frame in at least two of the rotational degrees of freedom as a function of progress through the progress length that compensates for relative rotation between the capture reference frame and the global reference frame in the at least two rotational degrees of freedom during the capture duration;
generating modified framing information that defines a modified viewing window of the visual content for presentation as a function of progress through the progress length of the video, wherein the modified framing information attenuates compensation for relative rotation between the capture reference frame and the global reference frame provided by the stabilized framing information in the at least two rotational degrees of freedom, where the modified framing information is derived from the stabilized framing information with a noise injection process that includes:
determining inverse stabilized framing information that reverses compensation of the stabilized framing information for the relative rotation between the capture reference frame and the global reference frame during the capture duration;
determining initial framing adjustment information by smoothing the inverse stabilized framing information over the progress length of the video;
obtaining a level of compensation mitigation;
determining final framing adjustment information by applying the level of compensation mitigation to the initial framing adjustment information; and
generating the modified framing information by applying the final framing adjustment information to the stabilized framing information;
determining the visual content within the viewing window defined by the modified framing information as a function of progress through the progress length of the video; and
presenting the visual content determined to be within the viewing window defined by the modified framing information as a function of progress through the progress length of the video.

2. The method of claim 1, wherein the inverse stabilized framing information includes quaternions describing rotation for individual frames of the video over the progress length of the video, and wherein smoothing the inverse stabilized framing information over the progress length of the video includes:
deriving, from the quaternions, separate angle of rotation functions describing rotation in individual ones of the at least two or more rotational degrees of freedom as a function progress through the progress length of the video;
generating smoothed angle of rotation functions for the individual ones of the at least two rotational degrees of freedom by separately smoothing the angle of rotation functions as a function of progress through the progress length of the video; and
deriving smoothed quaternions from the smoothed angle of rotation functions.

3. A method of framing videos, the method comprising:
obtaining video information defining a video, the video having a progress length, the video including visual content viewable as a function of progress through the progress length, the video captured by an image capture device over a capture duration in a capture reference frame associated with the image capture device, wherein during the capture duration the image capture device rotated in three rotational degrees of freedom with respect to a global reference frame of the visual content, thereby causing corresponding rotation between the capture reference frame and the global reference frame in the three rotational degrees of freedom,
obtaining stabilized framing information that defines a viewing window of the visual content for presentation as a function of progress through the progress length of the video, wherein the framing information includes viewing window orientation information that defines rotation of the viewing window with respect to the capture reference frame in at least two of the rotational degrees of freedom as a function of progress through the progress length that compensates for relative rotation between the capture reference frame and the global reference frame in the at least two rotational degrees of freedom during the capture duration;
generating modified framing information that defines a modified viewing window of the visual content for presentation as a function of progress through the progress length of the video, wherein the modified framing information attenuates compensation for relative rotation between the capture reference frame and the global reference frame provided by the stabilized framing information in the at least two rotational degrees of freedom, where the modified framing information is derived from the stabilized framing information with a noise injection process;
determining the visual content within the viewing window defined by the modified framing information as a function of progress through the progress length of the video; and
presenting the visual content determined to be within the viewing window defined by the modified framing information as a function of progress through the progress length of the video.

4. The method of claim 3, wherein the at least two of the three rotational degrees of freedom include pitch and roll.

5. The method of claim 3, wherein the at least two of the three rotational degrees of freedom include all three of the rotational degrees of freedom.

6. The method of claim 3, wherein the noise injection process includes:
determining inverse stabilized framing information that reverses compensation of the stabilized framing information for the relative rotation between the capture reference frame and the global reference frame during the capture duration;
determining initial framing adjustment information by smoothing the inverse stabilized framing information over the progress length of the video;
obtaining a level of compensation mitigation;
determining final framing adjustment information by applying the level of compensation mitigation to the initial framing adjustment information; and
generating the modified framing information by applying the final framing adjustment information to the stabilized framing information.

7. The method of claim 6, wherein the inverse stabilized framing information includes quaternions describing rotation for individual frames of the video over the progress length of the video.

8. The method of claim 7, wherein smoothing the inverse stabilized framing information over the progress length of the video includes:
deriving, from the quaternions, separate angle of rotation functions describing rotation in individual ones of the at least two or more rotational degrees of freedom as a function progress through the progress length of the video;
generating smoothed angle of rotation functions for the individual ones of the at least two rotational degrees of freedom by separately smoothing the angle of rotation functions as a function of progress through the progress length of the video; and
deriving smoothed quaternions from the smoothed angle of rotation functions.

9. The method of claim 8, wherein generating smoothing the angle of rotation functions includes bandpass filtering and/or an amplitude limiting function to the separate angle of rotation functions.

10. The method of claim 8, wherein the initial framing adjustment information includes the smoothed quaternions.

11. The method of claim 9, wherein determining the final framing adjustment information includes applying a spherical linear interpolation operation to the smoothed quaternions, and wherein the level of compensation mitigation determines a parameter of the spherical linear interpolation operation applied to the smoothed quaternions.

12. A system configured to frame videos, the system comprising:
one or more physical processors configured by machine-readable instructions to:
obtain video information defining a video, the video having a progress length, the video including visual content viewable as a function of progress through the progress length, the video captured by an image capture device over a capture duration in a capture reference frame associated with the image capture device, wherein during the capture duration the image capture device rotated in three rotational degrees of freedom with respect to a global reference frame of the visual content, thereby causing corresponding rotation between the capture reference frame and the global reference frame in the three rotational degrees of freedom,
obtain stabilized framing information that defines a viewing window of the visual content for presentation as a function of progress through the progress length of the video, wherein the framing information includes viewing window orientation information that defines rotation of the viewing window with respect to the capture reference frame in at least two of the rotational degrees of freedom as a function of progress through the progress length that compensates for relative rotation between the capture reference frame and the global reference frame in the at least two rotational degrees of freedom during the capture duration;
generate modified framing information that defines a modified viewing window of the visual content for presentation as a function of progress through the progress length of the video, wherein the modified framing information attenuates compensation for relative rotation between the capture reference frame and the global reference frame provided by the stabilized framing information in the at least two rotational degrees of freedom, where the modified framing information is derived from the stabilized framing information with a noise injection process;
determine the visual content within the viewing window defined by the modified framing information as a function of progress through the progress length of the video; and
present the visual content determined to be within the viewing window defined by the modified framing information as a function of progress through the progress length of the video.

13. The system of claim 12, wherein the at least two of the three rotational degrees of freedom include pitch and roll.

14. The system of claim 12, wherein the at least two of the three rotational degrees of freedom include all three of the rotational degrees of freedom.

15. The system of claim 12, wherein the noise injection process includes:
determining inverse stabilized framing information that reverses compensation of the stabilized framing information for the relative rotation between the capture reference frame and the global reference frame during the capture duration;
determining initial framing adjustment information by smoothing the inverse stabilized framing information over the progress length of the video;
obtaining a level of compensation mitigation;
determining final framing adjustment information by applying the level of compensation mitigation to the initial framing adjustment information; and
generating the modified framing information by applying the final framing adjustment information to the stabilized framing information.

16. The system of claim 15, wherein the inverse stabilized framing information includes quaternions describing rotation for individual frames of the video over the progress length of the video.

17. The system of claim 16, wherein smoothing the inverse stabilized framing information over the progress length of the video includes:
deriving, from the quaternions, separate angle of rotation functions describing rotation in individual ones of the at least two or more rotational degrees of freedom as a function progress through the progress length of the video;
generating smoothed angle of rotation functions for the individual ones of the at least two rotational degrees of freedom by separately smoothing the angle of rotation functions as a function of progress through the progress length of the video; and
deriving smoothed quaternions from the smoothed angle of rotation functions.

18. The system of claim 17, wherein generating smoothing the angle of rotation functions includes bandpass filtering and/or an amplitude limiting function to the separate angle of rotation functions.

19. The system of claim 18, wherein the initial framing adjustment information includes the smoothed quaternions.

20. The method of claim 19, wherein determining the final framing adjustment information includes applying a spherical linear interpolation operation to the smoothed quaternions, and wherein the level of compensation mitigation determines a parameter of the spherical linear interpolation operation applied to the smoothed quaternions.
